(19) United States
(12) Patent Application Publication
(10) Pub. No.: US 2010/0227556 A1
(43) Pub. Date: Sep. 9, 2010

(54) METHOD OF AUTOMATICALLY CONTROLLING OPERATION BETWEEN TERMINALS AND TERMINAL SUPPORTING THE SAME

(75) Inventors: Jin Yong KIM, Seoul (KR); Jung Yeob OH, Gyeonggi-do (KR); Myeong Lo LEE, Seoul (KR); Seung Woo SHIN, Seoul (KR); Kyung Hwa KIM, Seoul (KR)

Correspondence Address: CHA & REITER, LLC, 210 ROUTE 4 EAST STE 103, PARAMUS, NJ, 07652, US

(73) Assignee: SAMSUNG ELECTRONICS CO., LTD., Gyeonggi-Do (KR)

(21) Appl. No.: 12/714,635

(22) Filed: Mar. 1, 2010

(30) Foreign Application Priority Data
Mar. 3, 2009 (KR) 10-2009-0017921

(51) Int. Cl. H04B 7/005

(52) U.S. Cl. 455/41.2

(57) ABSTRACT

A method of automatically controlling operation between mobile terminals and a terminal supporting the same provide for automatic operation control terminals to control each terminal to recognize a specific operation generated in the terminal. Terminals generating the same operation signal automatically activate a near-distance communication module, and automatically forms a communication channel based on the near-distance communication module.

### CLAIM OF PRIORITY

This application claims the benefit of priority from Korean Patent Application No. 10-2009-0017921 filed in the Korean Intellectual Property Office on Mar. 3, 2009, the entire contents of which are incorporated herein by reference.

### BACKGROUND OF THE INVENTION

1. Field of the Invention

The present invention relates to a portable terminal for wireless communication. More particularly, the present invention relates to a method for automatically controlling operations between mobile terminals that improves communication between mobile terminals, particularly at close distances, and a mobile terminal supporting the same.

2. Description of the Related Art

In recent years, with the great development of miniaturization technology of miniaturizing, a size of a battery with a given capacity has decreased in size. Accordingly, devices such as mobile terminals have benefited from this improvement in battery technology, and such mobile terminals can now implement various optional functions that were not practical several years ago.

For example, the present-day mobile terminal often has a file playback function that may play an audio file and a video file, such as previously stored music, or learning modules, for example, English education data, so that a user can listen thereto. Furthermore, the present-day mobile terminal often has various additional functions including a camera function for photographing static images and a video camera function for tracking and photographing moving images.

Moreover, the present-day mobile terminal provides a mobile communication function using a base station and a function of forming a communication channel with a specific mobile terminal located in a near-distance and exchanging or controlling data. A Bluetooth module is used as a representative communication module of such a near-distance communication function.

In order to provide the near-distance communication function, the mobile terminal needs to perform various procedures for forming a communication channel and control. For example, upon formation of a communication channel based on a Bluetooth module, the mobile terminal requires selecting the Bluetooth module, activating the selected Bluetooth module, scanning other mobile terminals located within the area capable of communicating with the mobile terminal, and checking and selecting the other mobile terminals recognized according to the scan. Further, a conventional mobile terminal performs very complicated procedures to form the communication channel, such as the input of a PIN code for authentication between Bluetooth modules after selection of other mobile terminals.

### SUMMARY OF THE INVENTION

The present invention provides a method of automatically controlling operation between terminals that simplifies a procedure of forming a communication channel based on a near-distance communication module, automatically selecting mobile terminals required by a mobile terminal user, and performing operation control between other mobile terminals rapidly and easily, and a terminal supporting the operation of method.

In accordance with an exemplary aspect of the present invention, a method of automatically controlling an operation between terminals preferably includes: generating an operation signal by at least two terminals according to specific operations; automatically activating a near-distance communication module by each of the at least two terminals according to the generation of the operation signal; searching for other mobile terminals having experienced an occurrence of the same operation signal as the operation signal by at least one of the at least two terminals; and forming a near-distance communication channel between the other terminals having experienced occurrence of the same operation signal. In accordance with another exemplary aspect of the present invention, a terminal supporting automatic operational control preferably includes: a sensor sensing specific operation; an operation recognition unit generating an operation signal according to the specific operation based on a signal collected by the sensor; a near-distance communication module being automatically activated according to the operation signal transferred from the operation recognition unit; and a program controller searching for other terminals having experienced an occurrence of the same operation signal as the operation signal based on the automatically activated near-distance communication module, and controlling formation of a near-distance communication channel between the other terminals having experienced occurrence of the same operation signal.

In accordance with another exemplary aspect of the present invention, a method of automatically controlling an operation between terminals preferably includes: generating an operation signal by a terminal having a status in which a menu screen interface for operating a near-distance communication module is activated; and performing an automatic pairing procedure with another terminal based on the operation signal by the terminal.

In a method of automatically controlling an operation between terminals and a terminal supporting the same, a near-distance communication channel may be formed with another desired mobile terminal rapidly and easily and various services may be easily performed based on the near-distance communication channel.

### BRIEF DESCRIPTION OF THE DRAWINGS

The exemplary objects, features and advantages of the present invention will become more apparent from the following detailed description in conjunction with the accompanying drawings, in which:

FIG. 1 is a view illustrating automatic operation control between terminals according to an exemplary embodiment of the present invention;

FIG. 2 is a block diagram schematically illustrating the mobile terminal of FIG. 1;

FIG. 3 is a block diagram illustrating the control unit of FIG. 2;

FIG. 4 is a view illustrating automatic operation control between terminals according to another exemplary embodiment of the present invention; and

FIG. 5 is a flow chart illustrating an example of a method of automatically controlling operation between terminals according to an exemplary embodiment of the present invention.

### DETAILED DESCRIPTION

Hereinafter, exemplary embodiments of the present invention are described in detail with reference to the accompanying drawings. The same reference numbers are used throughout the drawings to refer to the same or like parts. Detailed descriptions of well-known functions and structures incorporated herein may be omitted to avoid obscuring appreciation of the subject matter of the present invention by a person of ordinary skill in the art.

While the present invention may be embodied in many different exemplary forms, specific exemplary embodiments of the present invention are shown in drawings and are described herein in detail, with the understanding that the present disclosure is to be considered as an exemplification of the principles of the invention and is not intended to limit the claimed invention to the specific embodiments illustrated herein.

Hereinafter, the present invention provides near-distance communication channel formation between terminals, and the terminals may be various portable terminals such as a mobile communication terminal, a headset, a music player, or a game machine.

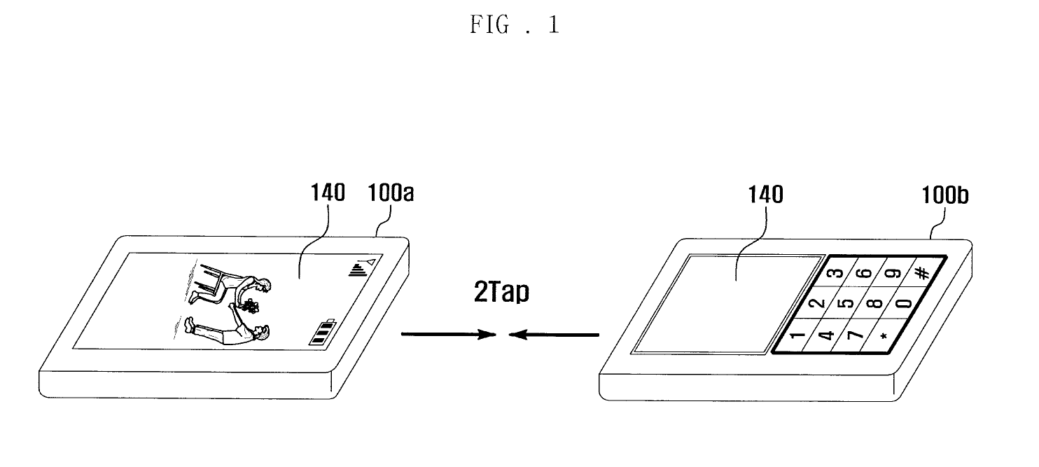

FIG. 1 is a view illustrating automatic operation control between terminals according to an exemplary embodiment of the present invention.

Initially, a first mobile terminal 100a and a second mobile terminal 100b each include a near-distance communication module and an operation recognition sensor, and accordingly form a near-distance communication channel based on the near-distance communication module according to control by a user.

The first mobile terminal 100a and the second mobile terminal 100b can be configured by various near-distance communication modules, for example, at least one of a Bluetooth wireless communication module, a Zigbee communication module, and an Ultra Wideband (hereinafter, UWB), etc. Hereinafter, the first mobile terminal 100a and the second mobile terminal 100b will be described as representative examples of mobile terminals including a Bluetooth wireless communication module.

With continued reference to FIG. 1, the first mobile terminal 100a and the second mobile terminal 100b each include at least one operation recognition sensor, for example, an acceleration sensing unit, and accordingly respective mobile terminals may recognize a “tap” operation to be a striking operation by a user when the user performs the “tap” operation striking an external side of the mobile terminal. Moreover, when the first mobile terminal 100a and the second mobile terminal 100b are inclined by a predetermined angle or are tilted in one direction based on the operation recognition sensor, they can recognize the corresponding inclination and tilt, and further recognize shaking or snap operation. Of course, it is within the spirit and scope of the present invention that the recognition may comprise be other than by a tap, including an optical sensor activation, or a touch or voice activation.

When the user applies a force to a mobile terminal with predetermined pressure to squeeze the mobile terminal, the first mobile terminal 100a and the second mobile terminal 100b may recognize a corresponding squeezing operation based on the operation recognition sensor. In order to recognize a corresponding squeezing operation based on the operation recognition sensor, the first mobile terminal 100a and the second mobile terminal 100b preferably include various sensors, for example, a piezo-electric sensor, a pressure sensor, an acceleration sensor, a gyroscopic sensor, or a proximity sensor.

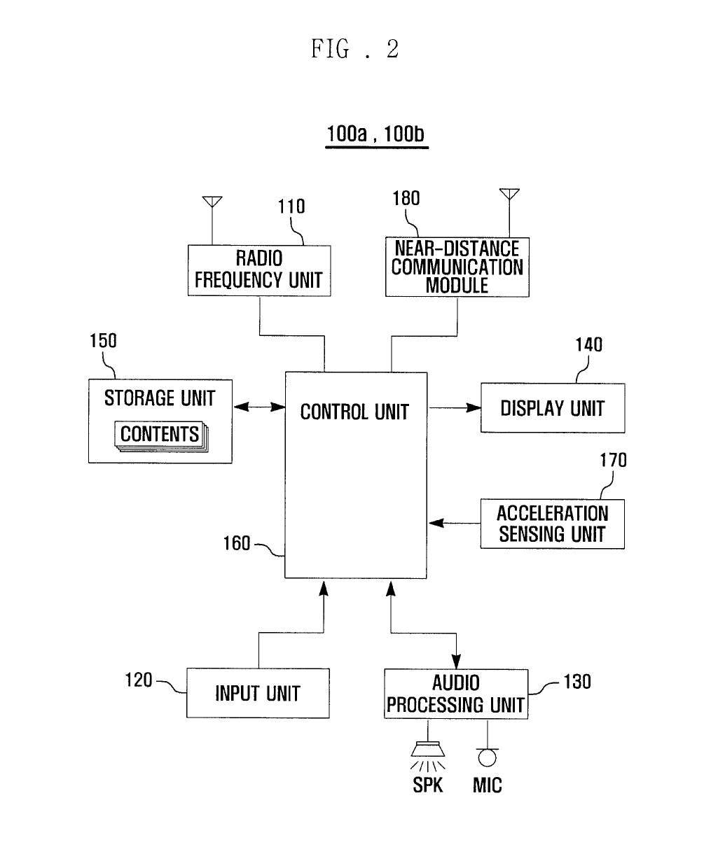

For the purpose of simplifying the description and clearly explaining main characteristics of the present invention, the acceleration sensing unit 170 (FIG. 2) is illustrated as a representative of the operation recognition sensor. However, the present invention is not limited thereto. As described above, the mobile terminals of the present invention can recognize various operations based on various sensors.

Still referring to FIG. 1, each of the first mobile terminal 100a and the second mobile terminal 100b includes a near-distance communication module, and may include an acceleration sensing unit 170 (FIG. 2). In this case, a mobile terminal user can dispose the first mobile terminal 100a and the second mobile terminal 100b to be facing each other. For example, the mobile terminal user can arrange the first mobile terminal 100a and the second mobile terminal 100b to be opposed to each other for communication, that is, the user can locate the mobile terminals in such a manner that an upward direction based on a screen output direction on a display unit 140 of the first mobile terminal 100a and that an upward direction based on a screen output direction on the display unit 140 of the second mobile terminal 100b face each other.

That is, as shown in FIG. 1, the first mobile terminal 100a and the second mobile terminal 100b can be disposed in a horizontal direction based on a shown direction. Accordingly, a right side (top portion if the user was holding the terminal to read the display) of the first mobile terminal 100a and a left side (top portion) of the second mobile terminal 100b can be disposed so as to face each other.

Next, a mobile terminal user can move the right side of the first mobile terminal 100a and the left side of the second mobile terminal 100b to contact with each other. For example, after the mobile terminal user squeezes the first mobile terminal 100a in the left hand, and squeezes the second mobile terminal 100b in the right hand, the user can contact the left side of the first mobile terminal 100a contact with the right side of the second mobile terminal 100b. Subsequently, the mobile terminal user repeats contact and separation between the first mobile terminal 100a and the second mobile terminal 100b to generate an operation signal in each mobile terminal (in this case two taps thus “2TAP” as shown in FIG. 1. Namely, if the mobile terminal user moves the first mobile terminal 100a and the second mobile terminal 100b to repeat contact and separation twice, the first mobile terminal 100a and the second mobile terminal 100b can recognize a tap operation twice according to the two strikes to generate a double-tap operation signal. In this case, at least one of the first mobile terminal 100a and the second mobile terminal 100b activates an application program according to the double-tap operation signal. To do this, at least one of the first mobile terminal 100a and the second mobile terminal 100b can provide a specific application program, for example, a function table setting activation of a Bluetooth communication module, and a terminal searching function according to the double-tap operation signal. Accordingly, the first mobile terminal 100a and the second mobile terminal 100b may activate a Bluetooth communication module according to the double-tap operation signal based on the function table, and attempt a procedure of searching for other terminals. In this case, at least one of the first mobile terminal 100a and the second mobile terminal 100b searches for a mobile terminal in which the same operation is generated, and controls formation of a near-distance communication channel with a corresponding mobile terminal. Namely, the double-tap operation signal may be used to control the Bluetooth communication module to be automatically activated, and can be used as an authentication signal necessary for forming the near-distance communication channel, for example, a signal identical with a PIN code input of the Bluetooth communication module. Hereinafter, detailed constructions of the first mobile terminal 100a and the second mobile terminal 100b will now be explained with detailed reference to FIG. 2 in detail.

FIG. 2 is a block diagram illustrating a detailed construction of at least one of the first mobile terminal 100a and the second mobile terminal 100b according to an exemplary embodiment of the present invention.

Prior to a description of FIG. 2, the first mobile terminal 100a and the second mobile terminal 100b may be of the same construction, or could be of a different construction. Accordingly, the first mobile terminal 100a and the second mobile terminal 100b will be described using one block diagram shown in FIG. 2. However, substantial constructions of the first mobile terminal 100a and the second mobile terminal 100b can be different than shown for one or both terminals. For example, when the second mobile terminal 100b is a music player or a headset, it may not include a radio frequency unit and a display unit.

Referring now to FIG. 2, each of the first mobile terminal 100a and the second mobile terminal 100b may preferably include a radio frequency unit 110, an input unit 120, an audio processing unit 130, a display unit 140, a storage unit 150, an acceleration sensing unit 170, a near-distance communication module 180, and a control unit 160.

The first mobile terminal 100a and the second mobile terminal 100b having a construction as described above may recognize an operation of a mobile terminal according to a signal collected by an acceleration sensing unit 170, and generate an operation signal according thereto. The first mobile terminal 100a and the second mobile terminal 100b may control, for example, the near-distance communication module 180 to be automatically activated according to the generated operation signal, and control formation of a near-distance communication channel between each other through the near-distance communication module 180. Hereinafter, each construction of the first mobile terminal 100a and the second mobile terminal 100b will be explained in detail.

The radio frequency unit 110 forms a communication channel for voice communication and a communication channel for transmitting data such as images under the control of the control unit 160. That is, the radio frequency unit 110 forms a voice calling channel, a data communication channel, and a video calling channel between mobile communication systems. In order to form these channels, the radio frequency unit 110 may include a radio frequency transmitter up-converting and amplifying a frequency of a signal to be transmitted, and a radio frequency receiver low-noise amplifying a received signal and down-converting a frequency of the signal. When the first mobile terminal 100a and the second mobile terminal 100b provide a mobile communication function, the radio frequency unit 110 can be used. The radio frequency unit 110 may classify another party's mobile terminals based on the other party's phone number and form a mobile communication channel based on the other party's phone number.

The input unit 120 includes a plurality of input keys receiving numerals or character information and a plurality of function keys for setting all kinds of functions. The function keys may preferably includes a direction key, a side key, and a hot key set to perform specific functions. The input unit 120 further generates a key signal associated with user setting and function control of a mobile terminal 100, and transfers it to the control unit 160. In particular, the input unit 120 can be configured by a key pad of a specific form and a key map in a touch screen. For example, the input unit 120 of the first mobile terminal 100a can be configured by a touch screen form. Consequently, while the first mobile terminal 100a can preferably store a key map in a storage unit 105, can output the key map to the display unit 140 according to a user's control, and can map a touch sensor to the output key map and so that the touch sensor can serve as an input unit. A hardware key pad can be provided at the second mobile terminal 100b. In this case, the key pad can be configured by a 3*4 key pad or a Qwerty key pad, DVORAK key pad.

The audio processing unit 130 includes a speaker SPK reproducing audio data to be transmitted and received at the time of a call, and a microphone MIC collecting a user's voice or other audio signals at the time of a call. When the first mobile terminal 100a and the second mobile terminal 100b comprise or include a music player, the audio processing unit 130 outputs an audio signal through the speaker SPK according to music playback, and can include the microphone MIC to record a user's voice or other audio signals. When the first mobile terminal 100a and the second mobile terminal 100b comprise a terminal such as a game machine in which separate voice recording is unnecessary, the microphone can be omitted.

The display unit 140 displays all types of menus of the mobile terminal 100, information input by a user, and information to be provided to the user. Namely, the display unit 140 may provide various screens according to a use of the mobile terminal, for example, an idle screen, a menu screen, a message creating screen, a call screen, a game screen, and a music playback screen. The display unit 140 can display a message according to activation of respective structural elements associated with the acceleration sensing unit 170 and the near-distance communication module 180. That is, in a state that the display unit 140 is outputting a specific screen, for example, a menu screen interface for operating a near-distance communication module, if the control unit 160 receives an operation signal recognized based on a sensor signal collected by the acceleration sensing unit 170, for example, a “2 Tap” signal indicating that a tap is generated twice, the control unit 160 can output it through the display unit 140. Accordingly, upon generation of the “2 Tap” signal, the display unit 140 displays a corresponding message to a user through a popup window. Meanwhile, when the near-distance communication module 180 is activated according to the “2 Tap” signal, the display unit 140 can output an image or a text indicating that the near-distance communication module 180 is automatically being activated, and output an image or a text indicating a state of attempting and completing formation of a communication channel between the first mobile terminal 100a and the second mobile terminal 100b according to automatic activation of the near-distance communication module 180. In this case, when a menu screen interface for operating a near-distance communication module is activated according to a user's input to output a corresponding screen on the display unit 140, the control unit 160 preferably controls at least one of an acceleration sensing unit corresponding to an operation recognition sensor and a near-distance communication module to be automatically activated. Furthermore, the display unit 140 may output various menu icons set by a user, a widget icon, or an icon corresponding to a file on an idle screen under the user's control. In the meantime, the display unit 140 may comprise a liquid crystal display (hereinafter, LCD) or an organic light emitting diode (hereinafter, OLED). However, any type of thin-film screen technology is compatible with the claimed invention. When the LCD or the OLED is configured in a form of a touch screen, the display unit 140 can be included in an input means. In order include the touch screen in an input means, a display panel and a touch sensor disposed on the display panel can be provided at the display unit 140. Namely, as in the first mobile terminal 100a, in a terminal without a separate hardware key, a touch sensor is provided at the display unit 140 and may function as an input unit. Moreover, a mobile terminal can provide various menu screens that may be performed based on a touch screen according to support of a touch screen in the display unit 140.

The storage unit 150 may store an application program necessary for function operation, an application program for operating an acceleration sensing unit, an application program for reproducing various stored files, an application program for operating a near-distance communication module, and a key map or a menu map for operating a touch screen according to an exemplary embodiment of the present invention. In this case, the key map and the menu map may be in various forms. Namely, the key map may comprise a keyboard map, a 3*4 key map, a qwerty key map, DVORAK key map, or a control key map for controlling operation of a currently activated application program. Furthermore, the menu map may be a menu map for controlling operation of a currently activated application program or a menu map having various menus provided from a mobile terminal as items. The storage unit 150 can include a program area and a data area largely.

An operating system (OS) for booting the mobile terminal 100 and for operating the foregoing structural elements and an application program playing various files can be stored in the program area. In this case, there is an application program for supporting a call function according to the presence of function support of the mobile terminal 100, a web browser for accessing an Internet server, a music playback application program for playing other sound sources, an image output application program for displaying photographs, and a moving image playback application program as examples of the application programs playing various files. In particular, an application program for operating the acceleration sensing unit 170, an application program for operating a touch sensor included in a touch screen, and an application program for operating a near-distance communication module can be stored in the program area of the present invention. Further, an operation control application program can be stored in the program area of the present invention to support automatically operating the near-distance communication module according to an operation signal generated based on a sensor signal collected by the acceleration sensing unit 170. The operation control application program is a program for controlling operation of the near-distance communication module according to the operation signal, and may be designed in a separate routine or be included in the application program for operating the near-distance communication module. The operation control application program is loaded under control of the control unit 160 to support control of a mobile terminal according to an embodiment of the present invention.

The data area comprises an area for storing data generated according to use of the mobile terminal, and various contents can be stored in the data area. In addition, when the display unit 140 is implemented by a touch screen, user data input through the touch screen may be stored in the data area. In particular, operation signals generated by the acceleration sensing unit 170, for example, a tap signal, an inclination signal, a tilt signal, a shaking signal, and a squeeze signal can be temporarily stored in the data area of the present invention. In this case, direction information of the operation signals may be also stored in the data area. For example, information regarding what part of the mobile terminal generates the tap signal that can be included in the tap signal. Information regarding which direction the mobile terminal is inclined to can be included in the inclination signal.

Similarly, the shaking signal and the squeeze signal may contain direction information of signal generation. A function table defining control of an application program according to the operation signal can be stored in the data area. For example, when the sensor signals collected by the acceleration sensing unit 170 are continuously generated operation signals in which double-taps have a predetermined time difference in a specific part of a mobile terminal, the function table may include command languages for controlling a near-distance communication module of a corresponding mobile terminal to be automatically activated, command languages for controlling searching for other mobile terminals generating the same operation signal as the operation signal generated by scanning a circumference, command languages for transmitting and receiving signals necessary to form the near-distance communication channel with other mobile terminals with the same operation signal and the near-distance communication module, and command languages for informing of the formation of a communication channel after transmission and reception of the signals. In this case, the function table does not separately perform an information check regarding authentication between other mobile terminals with the same operation signal, but can substitute corresponding authentication check procedure by a mobile terminal generating the same operation. Such activation or control of a functional table based application program will be described in detail in a description of a control unit below.

The acceleration sensing unit 170 is preferably disposed at one side of the mobile terminal, collects a sensor signal including an intensity of energy transferred by a user, a provided location and a provided direction of the energy, and transfers the sensor signal to the control unit 160. The acceleration sensing unit 170 collects signals regarding operation of the mobile terminal, may be substituted by other sensors, for example, a piezo-electric sensor, a pressure sensor, an acceleration sensor, a gyroscopic sensor, or a proximity sensor, or may be disposed with at least one of the sensors. Accordingly, the present invention is not limited to the acceleration sensing unit 170. A person of ordinary skill in the art should understand that the acceleration sensing unit 170 is a sensor for collecting signals according to the operation of the mobile terminal.

The near-distance communication module 180 preferably comprises a communication module that may form a near-distance communication channel with other mobile terminals. The near-distance communication module 180 may be configured by a Bluetooth module. The Bluetooth module is a standard for a radio frequency for near-distance and one-to-multiple transmission of voice and data and enables communication through a solid as well as metal. The Bluetooth module enables terminals within a distance ranging from 0.1 m to 10 m to communicate with each other. If amplitude of an electric wave is increased, the communication is expanded to 100 m. The Bluetooth module uses an Industrial Scientific Medical (ISM) band (2.402 GHz to 2.480 GHz) of 2.4 GHz band, transmission speed of 1 Mbps, and a frequency hopping method for interference prevention (79/23 hop, 1600 hop/sec), and low power consumption (idle state: 0.3 mA, maximum 30 mA at transmission and reception) is possible, and a transmission distance is 10 m, selectively up to 100 m. The Bluetooth module has a low guard band ranging from 2.4 GHz to 2.402 GHz and an up guard band ranging from 2.48 GHz to 2.4835 GHz to prevent signal interference. The Bluetooth module is classified into plural classes according to transmission power. Respective transmission powers of classes 1, 2, and 3 are 100 mW, 2.5 mW, 1 mW. Meanwhile, the Bluetooth module uses Guassian Frequency Shift Keying (GFSK) modulation and enables voice support of three channels with A-Law, u-Law PCM, and Continuous Variable Slope Delta Modulation (CVSDs). The Bluetooth module may perform a check procedure corresponding to a PIN code input based on an operation signal transferred from the acceleration sensing unit 170 during formation of a communication channel with other Bluetooth modules without a separate PIN code input check.

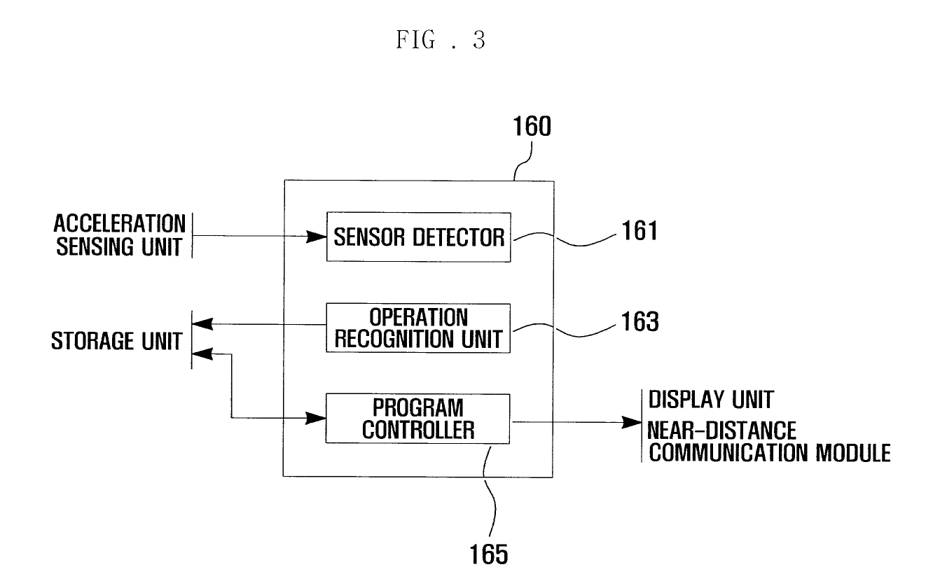

The control unit 160 controls power supply to respective structural elements of mobile terminals to perform initialization. When initialization is terminated, the control unit 160 controls the flow of respective signals so that an automatic operation control function of a near-distance communication module of the present invention can be supported to the respective structural elements. As shown in FIG. 3, the control unit 160 may include a sensor detector 161, an operation recognition unit 163, and a program controller 165 so that an automatic operation control function of a near-distance communication module of the present invention can be supported to the respective structural elements.

The sensor detector 161 monitors the acceleration sensing unit 170 to detect a sensor signal generated due to the operation of mobile terminals. The sensor detector 161 transmits the detected sensor signal to the operation recognition unit 163. The sensor detector 161 functions as a port for the acceleration sensing unit 170. When the acceleration sensing unit 170 transmits the sensor signal, the sensor detector 161 converts the transmitted sensor signal into a signal that the operation recognition unit 163 can process. In this case, the sensor detector 161 may filter the sensor signal transferred from the acceleration sensing unit 170. Namely, the sensor detector 161 provides a predetermined threshold value for the sensor signal. In a case where a physical force is provided to a mobile terminal, when the acceleration sensing unit 170 transfers a weak sensor signal that the operation recognition unit 163 cannot recognize, the sensor detector 161 can filter the weak sensor signal to process it as an invalid signal. Accordingly, the sensor detector 161 transfers validly recognized signals among sensor signals transferred from the acceleration sensing unit 170 to the operation recognition unit 163, and removes unnecessary sensor signals to minimize an operation recognition error. Meanwhile, in a case where the acceleration sensing unit 170 is disposed at a specific location of a mobile terminal, when a user strikes a specific part of the mobile terminal, a transfer time of vibration occurring due to striking to the acceleration sensing unit 170 can change according to its location. The acceleration sensing unit 170 can transfer the transfer time information to the sensor detector 161, the sensor detector 161 may estimate an occurring point of vibration based on the transfer time information, and estimate the occurring location of striking based on the occurring point of vibration.

The operation recognition unit 163 estimates what operation occurs in a mobile terminal based on the sensor signal from the sensor detector 161, and generates a corresponding operation signal. Namely, the operation recognition unit 163 can generate an operation signal, for example, an operation signal such as tapping, shaking snapping, inclination, and squeezing based on the sensor signal generated by the sensor detector 161. In detail, when a user strikes one side of a case of the mobile terminal, the sensor detector 161 receives the sensor signal from the acceleration sensing unit 170 and transfers the sensor signal to the operation recognition unit 163. Next, the operation recognition unit 163 can generate a tap operation signal based on the sensor signal. Further, when the uses shakes the mobile terminal, the operation recognition unit 163 can generate an operation signal corresponding to shaking or snapping using the sensor signal transferred from the sensor detector 161. At this time, the sensor detector 161 separately transfers a vibration wave generated due to the shaking operation of the mobile terminal and a vibration wave generated due to the snapping operation to the operation recognition unit 163. Accordingly, the operation recognition unit 163 may classify generating a shaking operation signal or a snapping operation signal based on the sensor signal.

The operation recognition unit 163 may further generate an indication operation signal according to a sensor signal detected by the sensor detector 161 and generate a squeeze operation signal according to the sensor signal detected by the sensor detector 161. Further, the operation recognition unit 163 may generate an operation signal corresponding to rubbing or squeezing based on the sensor signal transferred from the sensor detector 161. In particular, upon generation of an operation signal corresponding to tapping, the operation recognition unit 163 differently recognizes a tap operation signal based on application location information of a force included in the sensor signal transferred from the sensor detector 161, and can accordingly generate other operation signals. Namely, a user strikes a top part of the mobile terminal twice, the operation recognition unit 163 may generate an operation signal corresponding to a top double-tap based on the location information and the sensor signal transferred from the sensor detector 161, and may transmit the operation signal to the program controller 165.

The program controller 165 loads a function table stored in the storage unit 150, and controls the operation control execution of a mobile terminal according to an operation signal transferred from the operation recognition unit 163 with reference to the function table. In particular, the program controller 165 of the present invention controls a near-distance channel between mobile terminals to be automatically formed. In detail, when an operation signal in which a tap signal is generated twice at a set time interval, a shake signal with a set number and size, or a signal having a predetermined angle and maintaining an inclination in a predetermined direction is generated, the program controller 165 checks a function table for operation control according to the foregoing operation signal. Further, the program controller 165 can control the near-distance communication module to be automatically activated based on command languages included in the function table. When the near-distance communication module is initialized, the program controller 165 searches for other mobile terminals to form a near-distance communication channel. In this time, the program controller 165 can search for other mobile terminals generating the same operation signal at the same time. Otherwise, the program controller 165 can allow an error range within a constant time. Namely, the program controller 165 may control the near-distance communication module 180 to search whether there are other mobile terminals generating the same operation signal within the constant time. At this time, upon reception of a response signal from other mobile terminals having experienced occurrence of the same operation signal, the program controller 165 may control to substitute experienced occurrence detection for generation of the same operation for a signal value input procedure necessary for an authentication checking procedure. Subsequently, the program controller 165 forms a near-distance communication channel with another mobile terminal with having experienced occurrence of the same operation signal.

Meanwhile, after specific contents are designated in the first mobile terminal 100a, when an operation signal for forming the near-distance communication channel is generated, the program controller 165 may form the near-distance with another mobile terminal, namely, the second mobile terminal 100b through the foregoing procedures, and control the designated contents to be automatically transferred to the second mobile terminal 100b. In this case, the “designation” means that the first mobile terminal 100a user highlights a contents list stored in the storage unit 150.

For example, in a case where the near-distance communication module 180 is a Bluetooth module, when the program controller 165 receives a sensor signal from an acceleration sensing unit being an operation recognition sensor in a menu screen interface state using the Bluetooth communication module, a mobile terminal may generate an operation signal corresponding to the sensor signal and control automatic pairing with another mobile terminal to be performed based on the operation signal. At this time, when the menu screen interface using the Bluetooth module is activated, namely, when the user selects a Bluetooth menu screen interface, the program controller can control a Bluetooth module corresponding to a distance communication module to be automatically activated. When the menu screen interface using a Bluetooth module is activated according to a user's input, the program controller 165 may control the acceleration sensing unit 170 corresponding to an operation recognition sensor to generate an operation signal.

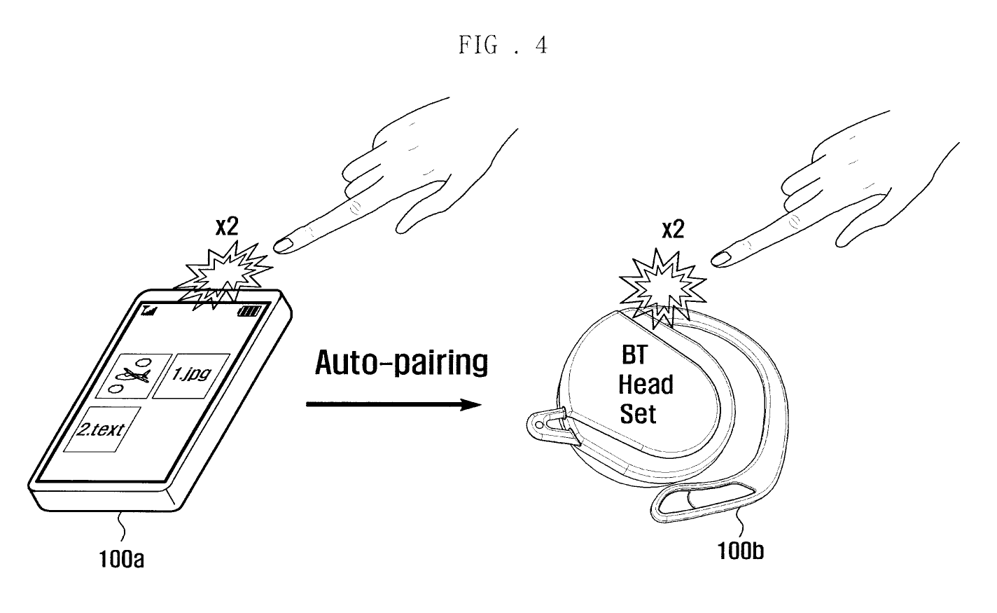

FIG. 4 is a view illustrating automatic operation control of a near-distance communication module according to another exemplary embodiment of the present invention.

In this particular exemplary embodiment, the first mobile terminal 100a may be a mobile communication terminal or a contents playback terminal. The second mobile terminal 100b may be a headset that receives and outputs a wireless audio signal from the first mobile terminal 100a.

Referring to FIG. 4, a user can generate a “2 tap” operation signal by striking a specific direction of the first mobile terminal 100a, for example, a upper side based on a display unit of the first mobile terminal 100a twice, and a “2 tap” operation signal by striking a specific direction of the second mobile terminal 100b, for example, a upper side based on a character written on a cover of the second mobile terminal 100b twice.

Accordingly, the first mobile terminal 100a automatically activates a near-distance communication module, and makes a control to scan an area. In this case, upon transmission of a query message, the first mobile terminal 100a can transmit the query message including information querying whether a terminal is a terminal generating the same operation signal as the operation signal. Namely, the query message may contain information of the operation signal and information of time when the operation signal is generated. When the second mobile terminal 100b among other mobile terminals receives the query message, the operation signal and the time information contained in the query message are checked by the second mobile terminal. The second mobile terminal can check, for example, whether the time information and the operation signal generated in the same time or within a predetermined allowable range, for example, 10 seconds before or after the time information are included in information temporarily stored in a storage unit. When there is the same operation signal as the operation signal contained in the query message, the second mobile terminal 100b can control to write generation information of the same operation signal in a response message to the query message and transmit the response messaged to the first mobile terminal 100a.

Then, when the first mobile terminal 100a receives the response message from the second mobile terminal 100b, it can control to form a near-distance communication channel with the second mobile terminal 100b. In this case, when the first mobile terminal 100a is a Bluetooth module, the first mobile terminal 100a may substitute a check of the same operation signal for a PIN code input procedure necessary for an authentication check procedure for the second mobile terminal 100b to form the near-distance communication channel.

Further, the first mobile terminal 100a can function as a master, and can control to perform various functions requested by a user, for example, an audio transmission function with contents and an audio signal transmission function according to calling.

In the description, it has been described that the user strikes an upper side of the first mobile terminal 100a and an upper side of the second mobile terminal 100b. However, according to a user's settings, a double-tap signal can be recognized as the same operation signal regardless of direction. When the first mobile terminal 100a and the second mobile terminal 100b attempt to form a near-distance communication channel, if there are many other mobile terminals at the circumference, an error can occur. In this case, preferably, the user sets that a double-tap and a generated direction of the tap are recognized as one operation signal.

Meanwhile, as in a case of FIG. 1, since the first mobile terminal 100a and the second mobile terminal 100b contact with each other in a predetermined direction, when an operation signal is generated, the first mobile terminal 100a and the second mobile terminal 100b may simultaneously generate the operation signal. At this time, the first mobile terminal 100a and the second mobile terminal 100b may control a near-distance communication module to be activated according to a set function table, and control to search for other mobile terminals forming a communication channel within a fixed radius. Accordingly, the first mobile terminal 100a may transmit a query message to the second mobile terminal 100b, and simultaneously the second mobile terminal 100b may transmit a query message to the first mobile terminal 100a. In this case, the first mobile terminal 100a and the second mobile terminal 100b randomly set a start time of activating a near-distance communication module within a predetermined time interval according to the generation of each operation signal, a mobile terminal having received the query message does not transmit a query message to another mobile terminal but makes a control to be operated as a slave terminal, with the result that channel collision or channel repetition occurring at the time of transmission and reception can be avoided. In the meantime, a near-distance communication module of the first mobile terminal 100a and a near-distance communication module of the second mobile terminal 100b use different transmission and reception channels. When the formation of plural communication channels is allowable, the first mobile terminal 100a and the second mobile terminal 100b can function as master-slave or slave-master, respectively.

Although the exemplary embodiment has been described based on a “2 tap” signal striking one side of a mobile terminal twice, the present invention is not limited thereto. Namely, the operation signal generated in the present invention may include, for example, various operation signals such as a “3 tap” operation signal striking the mobile terminal three times, an operation signal tilting the mobile terminal in a predetermined direction by a predetermined angle, an inclination operation signal inclining the mobile terminal in a predetermined direction by a predetermined angle, a squeeze signal applying a force in a predetermined direction to squeeze a body, and a shaking operation signal shaking the mobile terminal in a predetermined direction predetermined times. Further, operation control of the mobile terminal according to the operation signal may be set in a predetermined manner by a mobile terminal designer, and can be adjusted in a predetermined manner set by a user, or operation of the mobile terminal may be controlled according to a new operation signal. In particular, the user can control to automatically activate a near-distance communication channel with another mobile terminal having experienced occurrence of the same operation signal as the operation signal based on a specific operation signal set by the user.

Meanwhile, a mobile terminal functioning as a master can perform various operation controls according to the operation signal. Assuming that the first mobile terminal 100a functions as a master, if a “tap” signal is detected as the operation signal, it can control to transmit contents files designated by a user to the second mobile terminal 100b or to output a set game interface screen. Further, when a “shake” signal is detected as the operation signal, the first mobile terminal 100a can control to transmit contents designated by the user to all other mobile terminals connected to the first mobile terminal 100a in a broadcast manner. If the shake signal is detected once more, the first mobile terminal 100a can control to cancel a currently performing function, for example, a function of transmitting data in a broadcast manner.

If a squeeze signal is generated, the first mobile terminal 100a can request a file list stored by respective mobile terminals from all mobile terminals connected by wired and wireless means. In this case, if the file list is received from the respective mobile terminals, the first mobile terminal 100a can control to output the received file list on a display unit. Moreover, if an additional “squeeze” operation signal is generated, the first mobile terminal 100a can control storing the received file list in a storage unit. That is, in spite of the same operation signal, the first mobile terminal 100a can control to perform a different operation according to a state of a currently executed application program. If a “tilt” operation signal is generated, the first mobile terminal 100a can control transmitting of contents designated by the user to the second mobile terminal 100b, and to share the transmitted contents. If a “snap” operation signal is generated, the first mobile terminal 100a can control to cancel a near-distance communication channel with the second mobile terminal 100b. In this case, upon reception of a file list from a specific mobile terminal among plural mobile terminals, the first mobile terminal 100a can control to request transmission of a file list from another mobile terminal, and to accordingly receive and output a file list of a new mobile terminal.

As described herein above, constructions and functions of an operation control apparatus between mobile terminals, namely, an apparatus of supporting to automatically form a near-distance communication channel between mobile terminals according to an operation signal in accordance with an exemplary embodiment of the present invention have been explained. Hereinafter, a method of automatically controlling operation between mobile terminals based on the mobile terminal will be described in detail.

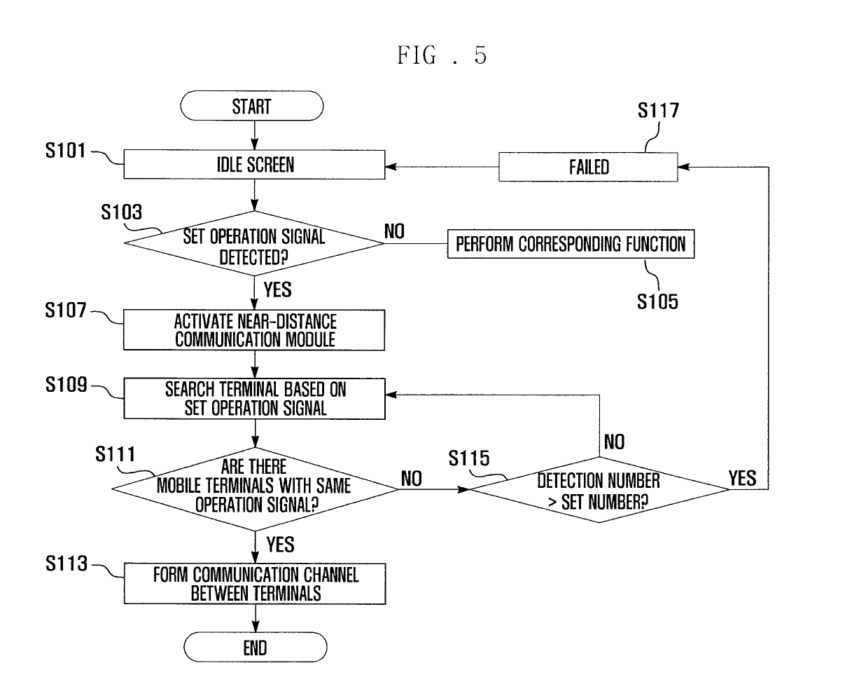

FIG. 5 is a flow chart illustrating a method of automatically controlling operation between mobile terminals according to an embodiment of the present invention.

Referring now to FIG. 5, in the method of automatically controlling operation between mobile terminals of the present invention, at (step S101), when power is supplied to a mobile terminal, a control unit of a first mobile terminal and a control unit of a second mobile terminal perform a booting procedure of the mobile terminal using the supplied power, and then initialize respective structural elements. At this time, a set idle screen can be output according to a type of the mobile terminal or only the initialization of the structural elements can be performed without output of the idle screen.

Next, at (step S103), the control unit of a first mobile terminal and the control unit of a second mobile terminal check whether or not a set operation signal is detected. To perform such detection, the control units may control operation recognition sensors, for example, a piezo-electric sensor, a pressure sensor, an acceleration sensor, a gyroscopic sensor, a proximity sensor, and an optical sensor to be activated.

As a result of the check in step 103, at (step S105), when the set operation signal is not detected, the control units can control to perform corresponding functions of respective mobile terminals, for example, a self-file playback function and a call function.

Meanwhile, at (step S107), when the set operation signal is detected in step 103, the control units of the first mobile terminal and the second mobile terminal can control to activate a near-distance communication module. To perform such activation, the control units check whether or not a sensor signal transferred from the sensor is valid. When the sensor signal is valid, the control units may recognize an operation signal corresponding to the sensor signal. Further, the control units load a function table stored in a storage unit, and control execution of functions according to the set operation signal based on the loaded function table. In this case, the function table can contain command languages for activating a near-distance communication module to form a communication channel upon generation of the set operation signal.

Then, at (step S109) a control unit of a first mobile terminal and a control unit of a second mobile terminal can control to search other mobile terminals forming a near-distance communication channel based on the set operation signal. Subsequently, at (step S111), the control units check whether there are mobile terminals having experienced occurrence of the same operation signal as the operation signal collected in step S103. The control units may control to transmit a query message including information of the operation signal and information of time when the operation signal is generated to mobile terminals located within a fixed radius. When the first mobile terminal transmits the query message to the mobile terminals located within a fixed radius, and the second mobile terminal transmits a response message to the query message to the first mobile terminal, at (step S113), the control unit of the first mobile terminal and the control unit of the second mobile terminal may form a communication channel between terminals.

When there are no terminals with having experienced occurrence of the same operation signal in step S111, the control unit of the first mobile terminal or the control unit of the second mobile terminal check whether a detection number is greater than a set number (step S115). When the detection number is less than or equal to the set number, the control units increases the detection number by “1” and the routine returns to step S109 and the following steps are repeatedly performed. When the detection number is greater than the set number in step S115, formation of a communication channel is recognized as “failure” and the routine returns to step S101 so that the control units can control to maintain an idle screen output state.

Although the exemplary embodiment has been described that the first mobile terminal and the second mobile terminal operate based on the same function table, a mobile terminal designer or a user may set the first mobile terminal and the second mobile terminal to operate based on different function tables. Namely, the first mobile terminal activates a near-distance communication module upon generation of a specific operation signal and transmits a query message for searching for mobile terminals having experienced occurrence of the same operation signal as the operation signal, and automatically forms a communication channel with a mobile terminal transmitting a response message to the query message. In this procedure, when an authentication check procedure is necessary as in a Bluetooth module, the first mobile terminal can control to substitute the operation signal check procedure for the authentication check procedure.

In the meantime, the same operation signal as the operation signal generated by the first mobile terminal is generated, the second mobile terminal can control to only activate a near-distance communication module and to wireless wait until a query message is received. Subsequently, upon reception of the query message from the first mobile terminal, the second mobile terminal creates a response message based on operation signal information temporarily stored in a storage unit, and transmits the response message to the first mobile terminal, and forms a near-distance communication channel according to control of the first mobile terminal.

A case where the near-distance communication module is a Bluetooth module is described by way of example. The first mobile terminal can control to activate a menu screen interface using the Bluetooth module according to a user's input. In this case, the first mobile terminal can automatically activate at least one of an operation recognition sensor and the Bluetooth module. Here, the first mobile terminal can perform automatic pairing according to generation of the operation signal. In detail, upon generation of the operation signal, the first mobile terminal searches for another mobile terminal, stores the operation signal, and compares an operation signal of the other mobile terminal with the operation signal. If a result of the comparison satisfies a predetermined condition, namely, the operation signals are identical with each other or the operation signal of the other mobile terminal is a recognized value within a predetermined allowable range, the first mobile terminal can control to perform an automatic pairing procedure with the other mobile terminal. Here, when a Bluetooth module corresponding to the near-distance communication module is not activated, the first mobile terminal can additionally activate the Bluetooth module.

As mentioned above, the method of automatically controlling operation between terminals according to an exemplary embodiment of the present invention can automatically activate the near-distance communication channel according to generation of the operation signal, and perform respective procedures to automatically form the near-distance communication channel between two terminals. In this case, when there is an authentication check procedure according to characteristics of a communication module, the authentication check procedure can be controlled to be substituted based on the operation signal. Further, according to the control of a mobile terminal, after a specific file is previously designated, the designated specific file can be controlled to be automatically transmitted to a terminal forming a communication channel together therewith. As described above, the automatic operation control method of the present invention can support to easily form a near-distance communication channel, and to provide a convenient use example case associated with specific functions.

The above-described methods according to the present invention can be realized in hardware or as software or computer code that can be stored in a recording medium such as a CD ROM, a RAM, a floppy disk, a hard disk, or a magneto-optical disk or downloaded over a network, so that the methods described herein can be executed by such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein.

Although exemplary embodiments of the present invention have been described in detail hereinabove, a person of ordinary skill in the art should be clearly understand that many variations and modifications of the basic inventive concepts herein described, which may appear to those skilled in the art, will still fall within the spirit and scope of the exemplary embodiments of the present invention as defined in the appended claims.

What is claimed is:

1. A method of automatically controlling operation between two or more terminals, comprising:
generating an operation signal by at least two terminals according to a specific operation;
activating a near-distance communication module in each of the at least two terminals according to the generation of the operation signal;
searching for other terminals having experienced occurrence of a same operation signal as the operation signal generated by at least one of the at least two terminals; and
forming a near-distance communication channel between the other terminals having experienced occurrence of the same operation signal.

2. The method of claim 1, wherein activating the near-distance communication module in each of the two terminals activates a respective Bluetooth module included in each of terminal, and wherein a code input procedure for an authentication check of the other terminals to be executed according to the activation of the Bluetooth module is omitted and is replaced by a procedure of checking the operation signal for a code input procedure.

3. The method of claim 1, wherein searching for other terminals comprises:
generating a query message containing information regarding the operation signal and information regarding a generation time of the operation signal;
transmitting the generated query message to at least one other terminal; and
searching for a particular terminal with the same information as the information contained in the query message from among the other terminals.

4. The method of claim 1, wherein the two terminals comprise a first mobile terminal and a second mobile terminal, and when the first mobile terminal and the second mobile terminal contact each other in a predetermined direction to generate the operation signal, searching for other terminals comprises:
generating a query message containing information regarding the operation signal, information regarding a location where the operation signal is generated, and information regarding a generation time of the operation signal;
transmitting the generated query message to at least one other terminal; and
searching for a terminal with a same information as the information contained in the query message from among the other terminals.

5. The method of claim 1, wherein the two terminals comprise a first mobile terminal and a second mobile terminal, and when one side of the first mobile terminal and one side of the second mobile terminal contact each other during generation of the operation signal to generate an operation signal according to the contact of the first and second mobile terminals, searching for other terminals comprises:
generating a query message containing information regarding the operation signal and information regarding a time when the operation signal is generated, and regarding allowable error information for recognizing as the same operation signal based on generation time of the operation signal;
transmitting the generated query message to at least one other terminal; and
searching for a particular terminal with information identical to information contained in the query message from among the other terminals.

6. The method of claim 1, further comprising designating specific contents stored in a storage unit prior to generating the operation signal.

7. The method of claim 6, further comprising transmitting the designated specific contents to the other terminals after forming the near-distance communication channel.

8. The method of claim 1, wherein the two terminals comprise a first mobile terminal and a second mobile terminal, and wherein searching other terminals comprises:
transmitting by the first mobile terminal a query message for searching for the second mobile terminal according to the generation of the operation signal, in which the first mobile terminal and the second mobile terminal automatically activate the near-distance communication module; and
waiting for reception of the query message by the second mobile terminal after the near-distance communication module is activated.

9. The method of claim 1, further comprising storing the generated operation signal by the two terminals.

10. The method of claim 1, wherein the two or more terminals comprise a first mobile terminal and a second mobile terminal, and wherein one side of the first mobile terminal and one side of the second mobile terminal generate an operation signal by at least one of (1) coming within a predetermined distance of each other recognizable by respective sensors in the first and second mobile terminals; or (2) a touch activation comprising sensing a squeezing at a designated portion with a predetermined minimum amount of pressure of at least one of the first and second mobile terminals; or (3) a voice activation

11. A terminal for supporting automatic operation control, the terminal comprising:
a sensor sensing a specific operation;
an operation recognition unit generating an operation signal according to the specific operation associated with a signal collected by the sensor;
a near-distance communication module being activated according to the operation signal transferred from the operation recognition unit; and
a program controller searching for at least one other terminal having experienced an occurrence of the same operation signal as the operation signal based on the activated near-distance communication module, and for controlling formation of a near-distance communication channel between the at least one other terminal having experienced an occurrence of the same operation signal.

12. The terminal of claim 11, further comprising a storage unit temporarily for storing the operation signal.

13. The terminal of claim 11, wherein, when the near-distance communication module comprises a Bluetooth module, the program controller omits a code input for an authentication check of the at least one other terminals, and substitutes a check of the operation signal for the code input.

14. The terminal of claim 11, wherein the program controller makes a control to generate a query message including the operation signal and generated time information of the operation signal, and to search for at least one other terminals with the same information as the information contained in the query message,
or makes a control to generate a query message containing the operation signal, and generated location information and time information of the operation signal, and to search for at least one other terminals with the same information as the information contained in the query message,
or makes a control to generate a query message containing information of the operation signal and information of time when the operation signal is generated, and allowable error information for recognizing as the same operation signal based on the time when the operation signal is generated, and to search for at least one other terminals with the same information as the information contained in the query message,
or forms the near distance communication channel and then controls automatic transmission of the designated specific contents to at least one other mobile terminals when specific contents stored in a storage unit are designated prior to generating the operation signal.

15. The terminal of claim 11, wherein the terminal and said at least one other terminal comprise a first mobile terminal and a second mobile terminal, and wherein one side of the first mobile terminal and one side of the second mobile terminal generate an operation signal by at least one of (1) coming within a predetermined distance of each other recognizable by respective sensors in the first and second mobile terminals; or (2) a touch activation comprising sensing a squeezing at a designated portion with a predetermined minimum amount of pressure of at least one of the first and second mobile terminals; or (3) a voice activation.

16. A method of automatically controlling operation between terminals, comprising:
generating an operation signal by a first terminal having a status in which a menu screen interface for operating a near-distance communication module is activated; and
performing an automatic pairing procedure with a second terminal based on the operation signal generated by the first terminal.

17. The method of claim 16, further comprising automatically activating an operation recognition sensor by the first terminal when the menu screen interface is activated, wherein performing an automatic pairing procedure comprises:
activating a near-distance communication module based on the operation signal and searching for the second terminal using the activated near-distance communication module by the first terminal;
storing the operation signal by the first terminal;
comparing an operation signal of the second terminal located by the first terminal with the stored operation signal; and
performing an automatic pairing with the second terminal when the comparison result satisfies a predetermined condition.

18. The method of claim 17, wherein performing an automatic pairing procedure comprises:
searching for the second terminal based on the operation signal by the terminal;
storing the operation signal by the first terminal;
comparing an operation signal of the second terminal located by the first terminal with the stored operation signal; and
performing an automatic pairing with the second terminal when the comparison result satisfies a predetermined condition.

19. The method of claim 18, wherein searching for another terminal comprises:
generating a query message including containing information of the operation signal, information on a location where the operation signal is generated, and information of time when the operation signal is generated; or
generating a query message containing information of the operation signal, information of time when the operation signal is generated, and error allowable information for recognizing as the same operation signal based on the time when the operation signal is generated.

20. The method of claim 16, further comprising at least one of:
designating specific contents stored in a storage unit prior to generating the operation signal; automatically transmitting the designated specific contents to the other terminal after performing the automatic pairing procedure;
further substituting the operation signal check procedure for a code input procedure for authentication check of the second terminal; and
activating the local communication module when the menu screen interface is activated.
